(19) United States
(12) Patent Application Publication
(10) Pub. No.: US 2014/0279073 A1
(43) Pub. Date: Sep. 18, 2014

(54) SUBSCRIPTION CONFIGURATION MODULE AND METHOD

(71) Applicant: BRIGHTPOINT, INC., Indianapolis, IN (US)

(72) Inventors: Odd Amund Tangen, Rasta (NO); Vladimir Petrov, Oslo (NO)

(73) Assignee: Brightpoint, Inc., Indianapolis, IN (US)

(21) Appl. No.: 13/845,498

(22) Filed: Mar. 18, 2013

(51) Int. Cl. G06Q 30/06

(52) U.S. Cl. CPC G06Q 30/0641
USPC 705/14.73; 705/27.1

(57) ABSTRACT

The various embodiments disclosed herein provide a subscription configuration module that may provide content directly to a retailer's website in order to calculate current pricing based upon subscription pricing and subsidies currently being offered by one or more mobile communications network providers. The content provided to the retailer's website matches the look and feel of the rest of the website, such that the user of the website normally is unaware that the content has been provided from another source. The subscription configuration module is always updated with the current business rules and pricing in effect for any particular provider, so that the retailer is always assured of receiving the pricing and subsidies then currently in effect, and the retailer is thus relieved of the need to continuously keep this portion of their e-commerce website up-to-date. In many embodiments, the subscription configuration module is provided by a distributor apart from the retailer and provider.

### TECHNICAL FIELD OF THE DISCLOSURE

The present disclosure generally relates to automated software systems and methods and, more particularly, to a subscription configuration module and method.

### BACKGROUND OF THE DISCLOSURE

There exist many types of products and services, in many different industries, in which the price of the product and/or service varies depending upon a number of factors. To give just one non-limiting example, mobile telephones are produced by various manufacturers and are sold (usually through a distributor and then through a retailer) to a retail customer. Retail customers must choose a particular mobile telephone company (the “provider”) to provide communications services for use with the mobile device. Each provider typically has several different subscription service plans having various lengths of commitment, options, and pricing. Furthermore, the price paid by the retail customer for the mobile telephone and service plan can in most instances vary depending upon a great number of factors, such as which provider is chosen to provide service, which of several service plans offered by the provider is chosen, and whether any current subsidies are being offered by the provider and/or the mobile device manufacturer for the chosen service plan and/or mobile device, to name just a few non-limiting examples.

Because there are normally multiple mobile providers providing services in any particular geographic area, and each mobile provider will normally have a variety of service plan options and subsidies offered (variable by both type of plan and mobile telephone purchased), there is no standard way for the mobile telephone retailer to integrate its pricing system with a variety of mobile providers. For example, the retailer may desire to have a website that allows a potential customer to browse a variety of mobile telephones and service plans that are available from a variety to providers and to compare prices for different packages. This is typically a logistics nightmare for the retailer, as each provider prices its offerings in different package configurations, offers different types of subsidies for various products and services, and changes these parameters on a regular basis. Thus, not only does a substantial amount of work need to be performed by the retailer to develop the configuration and pricing section of their website, but much of the underlying data is subject to constant change by the providers. This approach makes it very hard, costly and resource/time consuming for a retailer to integrate its sales and purchase systems even with a single provider, not to mention trying to do this for multiple providers. The result is that even large retailers rely on manual routines when it comes to handling subscriptions/subsidies, thereby losing much of the efficiency normally provided by integrated web-based solutions. Additionally, many customers become frustrated and suspicious as to why they are not able to simply be told the price of a particular package with the click of a button on the website.

It can be seen, therefore, that there is substantial room for improvement in this process.

### SUMMARY OF THE DISCLOSURE

In one embodiment, a computer-implemented system is disclosed, comprising: a provider server operatively coupled to a network and storing subscription information relating to one or more subscription plans; a retailer server operatively coupled to the network and hosting a website operative to display at least a portion of said information relating to one or more subscription plans; a customer browser operatively coupled to the network and operative to view said website; and a third party server operatively coupled to the network and storing a subscription configuration module, wherein the subscription configuration module is operative to: receive a request from the retailer server for information about said one or more subscription plans; retrieve from the provider server said information relating to said one or more subscription plans; and inject content including said information about said one or more subscription plans into the customer's browser.

In another embodiment, a method is disclosed, comprising the steps of: a) storing subscription information relating to one or more subscription plans on a provider server; b)

hosting a website on a retailer server operative to display at least a portion of said information relating to one or more subscription plans; c) viewing said website with a customer browser; and d) providing a subscription configuration module stored on a third party server, wherein the subscription configuration module is operative to: d.1) receive a request from the retailer server for information about said one or more subscription plans; d.2) retrieve from the provider server said information relating to said one or more subscription plans; and d.3)

inject content including said information about said one or more subscription plans into the customer's browser.

Other embodiments are also disclosed.

### BRIEF DESCRIPTION OF THE DRAWINGS

FIG. 1 is a schematic block diagram illustrating the high level data flows that occur in some embodiments;

FIG. 2. is a website screen of a mobile device retailer that requires content to be placed therein, according to one of the presently disclosed embodiments;

FIG. 3. is the website screen of FIG. 2 in which content has been placed therein by the third party subscription configuration module according to one of the presently disclosed embodiments;

FIGS. 4-6 are detailed data flows for one embodiment;

FIG. 7 is a schematic block diagram of the elements and sub-elements that are executed during the process of FIGS. 4-6;

FIG. 8 is a detailed data flow for one embodiment, keyed to the elements illustrated in FIG. 7;

FIG. 9 is a schematic flow chart illustrating one embodiment process for assigning a new telephone number for a customer;

FIG. 10 is a schematic flow chart illustrating one embodiment process for upgrading/porting a telephone number for a customer;

FIG. 11 is a schematic flow chart illustrating one embodiment process for performing a credit check for a customer;

FIG. 12 is a schematic flow chart illustrating one embodiment process for confirmation of an order for a customer;

FIG. 13 is a schematic flow chart illustrating one embodiment process for allowing a retailer to pick a pre-order;

FIG. 14 is a schematic flow chart illustrating one embodiment process for allowing a retailer to request pre-delivery of devices; and

FIG. 15 is a schematic flow chart illustrating one embodiment process for allowing a retailer to attempt to cancel a pre-existing order.

### DETAILED DESCRIPTION OF THE VARIOUS EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

The various embodiments disclosed herein provide a subscription configuration module that may provide content directly to a retailer's website in order to calculate current pricing based upon subscription pricing and subsidies currently being offered by one or more mobile communications network providers. The content provided to the retailer's website matches the look and feel of the rest of the website, such that the user of the website normally is unaware that the content has been provided from another source. The subscription configuration module is always updated with the current business rules and pricing in effect for any particular provider, so that the retailer is always assured of receiving the pricing and subsidies then currently in effect, and the retailer is thus relieved of the need to continuously keep this portion of their e-commerce website up-to-date. Furthermore, as the retailer expands into additional geographic markets, the subscription configuration module may continue to be relied upon to provide subscription pricing and subsidy information that is relevant to that geographic market. This allows the retailer to capitalize on the website content that it has already developed, such that only minimal effort will have to be employed to translate the website content to the requirements of the new geographic market, since the subscription pricing and subsidy portion will automatically be adapted by the subscription configuration module. In many embodiments, the subscription configuration module is provided by a distributor apart from the retailer and provider. In these embodiments, the distributor is able to provide a simple solution (from the viewpoint of the retailer) that allows the retailer to easily manage multiple complex provider integrations with the retailer's e-commerce system.

Referring now to FIG. 1, there is illustrated a schematic block diagram illustrating the high level data flows that occur in some embodiments of the presently disclosed embodiments. At one end of the information chain are a plurality of providers 10, each of which at any moment in time maintains one or more service subscription plans, which may include one or more subsidies (such as, in the mobile telephone market for example, a discount on the price of a service plan purchased with a designated model of mobile telephone or vice versa). These subscription plans and subsidies, as well as their various combinations, are subject to change by the provider 10 at various times.

The information regarding the currently available subscription plans and subsidies is provided to the third party 20 who provides a subscription configuration module to the retailer 30. In the embodiments described below, the third party 20 may be a mobile device distributor and that designation will be used hereinafter. The provider 10, distributor 20, and retailer 30 each maintain one or more separate servers containing various information as discussed herein. These servers are coupled together for communication therebetween, such as by being coupled to a computer network such as the Internet or the world wide web. The distributor 20's server communicates with the server of each provider 10, for example by use of a custom application programming interface (API) integration adapter designed to provide the required data interchange integration with the provider 10's server(s). To provide the information from the subscription configuration module to the retailer 30, the distributor 20 accesses content from a database (not shown separately) to be combined with the information obtained from the providers 10. For example, the content may include formatting and functionality to match other content on a website of the retailer 30, such that the subscription configuration module is able to seamlessly inject content into the website operated by the retailer 30. For example, a customer may operate a browser 40 that accesses a website operated by or on behalf of the retailer 30. While the customer browser 40 is viewing various mobile device options, provider options, and subscription plan options, the distributor 20 is injecting content 50 directly into the customer's browser so that the current pricing for the options selected by, or available to, the customer are displayed seamlessly on the customer's browser 40. In many embodiments, the customer is unaware that the content 50 has been injected from a distributor, since the subscription configuration module has been programmed to match the look and feel of the retailer 30's website. Inputs 52 made by the customer in the web browser 40 that relate to subscription configuration are sent back to the distributor 20 for further processing.

For example, FIG. 2 illustrates a website of a retailer 30 that is displaying information about a particular mobile device on a customer's browser 40. In the section 60, the retailer 30 desires to display several subscription options available to the customer for this mobile device, taking into account any subsidies that are currently being offered. The content 50 for the section 60 is injected by the distributor 20 subscription configuration module based upon options that are available to the customer as defined by the various providers 10. As seen in FIG. 3, the content 50 for the section 60 is injected by the distributor 20 subscription configuration module in order to complete the website view displayed on the customer's browser 40. When the customer clicks the button 54 on his browser, his browser bypasses the retailer 30's server and retrieves the new content for the section 60 directly from the distributor 20's server.

After perusing the options available, the customer is able to purchase equipment and/or service plans using the retailer 30's existing shopping flow programmed into the retailer 30 website, with the website receiving the pricing information for such purchase from the subscription configuration module. For example, the customer may select one of the “Choose” buttons 62 shown in FIG. 3 in order to enter the retailer 30's shopping flow.

FIGS. 4-6 illustrate more detailed data flows for one embodiment of the subscription configuration module disclosed herein. At the provider level 10, one or more providers 10 supply business rules to the distributor 20. For example, in some embodiments, the business rules 100 may include pricing for various subscription plans and mobile devices, as well as subsidies that are currently available to incentivize the customer to choose a particular subscription plan, mobile device, or combination of subscription plan and mobile device. In some embodiments, the subscription configuration module communicates with each of the providers 10 through an application programming interface (API) and customized integration adapters.

Using this information, the subscription configuration module, resident on a server controlled by distributor 20, develops content 50 that is displayed as part of the website maintained by the retailer 30 and is viewed by the customer's web browser 40. In some embodiments, the business rules engine of the subscription configuration module communicates through a front-end API with the retailer 30's website using, for example, a REpresentational State Transfer (REST) software architecture. In some embodiments, the customer's browser 40 communicates with the retailer 30's server, and also with the distributor 20's server through a front end API and a web client. In some embodiments, once the retailer 30 server has indicated to the subscription configuration module which product data is to be presented, the customer's browser communicates and exchanges data directly with the subscription configuration module on the distributor 20's server. Once the customer has confirmed through the subscription configuration module graphical user interface which subscription is to be purchased, further data exchange about the subscription is conducted between the subscription configuration module and the retailer 30's server. Therefore, as shown in FIG. 4, an option provided to the customer is to choose Plan Large from Provider One. The customer selects this option by clicking on the button 62 and this answer 52 is transferred to the subscription configuration module on the distributor 20's server, which asks the customer to enter their telephone number.

Once the customer clicks on the next button 102, the subscription configuration module determines if the customer qualifies to purchase this subscription. For example, the subscription configuration module may pass the customer's telephone number to the provider 10 offering the selected subscription to determine the current state of any prior subscription purchased by the customer. If such prior subscription period has not yet expired, then the customer may be determined at 104 by the provider to not be eligible to purchase a new subscription and this decision is passed to the distributor 20 who will indicate this in section 60 of the website being displayed on the customer's browser.

If, on the other hand, the provider 10 determines at 106 that the customer is qualified to purchase this subscription, the distributor 20 server indicates this in section 60 of the website being displayed on the customer's browser. For security purposes, the customer is asked to positively identify himself by entering his name into the field 108, his social security number in the field 110, and a verification code into the field 112. The verification code may be sent by SMS message to the mobile telephone number entered by the customer and the customer is asked to enter this verification code into the field 112. Once the requested information is entered, the customer clicks the button 114 and this information is provided to the provider 10 for verification. If the information does not match the information already associated with the mobile telephone number entered by the customer, then the provider 10 determines at 116 that such an error has been made and the customer is notified by the distributor 20 through the section 60 of the retailer 30's website.

If, on the other hand, the information matches, then the provider 10 indicates at 118 the approval to purchase the chosen plan and two actions are taken. First, the approval causes the new subscription to be placed in the distributor 20's subscription activation queue 120. Secondly, the approval causes the subscription to be added to the shopping basket 122 on the retailer 30's website. Continuing on FIG. 5, the customer may proceed to the checkout section of the retailer 30's website by clicking the button 124 on his browser 40. This causes the retailer 30's website to display the Order Review section 126. If the customer believes that the order is correct, he clicks the button 128 to complete the checkout process. Payment handling to complete the sale is performed by the retailer 30's website. An indication that the checkout is complete is displayed on the retailer 30's website at 130. At this point, additional checks may be made by the distributor 20 and/or provider 10 to determine that the customer is authorized to make the purchase. For example, a check may be made to determine if the customer is an existing customer of the provider 10, the legal owner of the telephone number with the authority to port the number to another provider 10, a credit check, and/or a delivery address check. Based upon any or all of these checks, the provider 10 may determine whether to authorize the purchase of the subscription. Those skilled in the art will recognize that the order purchasing and checkout procedure disclosed above is exemplary only, and that a great many variations in this procedure may be made within the scope of the currently disclosed and claimed embodiments.

The completion of the checkout procedure is communicated from the retailer 30's website to the subscription activation queue 120 so that the subscription configuration module knows that activation of the subscription may proceed. Continuing to FIG. 6, completion of the checkout process also results in the retailer 30 informing (at 134) the distributor 20 of the International Mobile Equipment Identity or IMEI number associated with the mobile device for which the subscription was purchased. This may be done manually (by the retailer manually entering the information into the computer) or may be part of the automatic processing if the distributor 20 originally provided the mobile device to the retailer 30.

The subscription activation queue 120 of the subscription configuration module notifies (at 136) the provider 10 to verify that the retailer has completed the sale of a subscription for which a subsidy is attached. The provider 10 makes payment of the subsidy at 138 to the retailer 30 and the transaction is thus completed. Any communication 139 between the retailer 30 and the provider 10 goes through the subscription activation queue 120. It will be appreciated that the subscription configuration module not only provides all of the pricing, options and verifications required for the retailer 30 to advertise the current cost of various subscription plans available from the various providers 10, but it also initiates the payment of the required subsidy from the provider 10 to the retailer 30 for each sale in which a subsidy is appropriate. The subscription configuration module intermediates between the customer and the retailer 30 to provide the most current product/subscription options available and to receive the customer's input regarding these. The subscription configuration module also intermediates between the customer and the provider 10 during the subscription configuration phase, such as by performing various checks like customer social security number and credit checks, sometimes integrating with the provider 10's internal systems. Additionally, the subscription configuration module intermediates between the retailer 30 and the provider 10 after the subscription configuration phase, such as informing the provider 10 about the order lifecycle, product identification numbers (e.g., IMEI, ICC, etc.) for the products to which the subscription relates, and other information flows during the fulfillment phase.

Referring now to FIG. 7, there are illustrated schematically the various elements and sub-elements that are executed during the process of FIGS. 4-6. For ease of reference, the elements are labeled 1-8 in FIG. 7 and are keyed to the same reference designators shown in FIG. 8, which is a reproduction of FIG. 4. Beginning with element 1, a determination of the subscriptions available involves checking provider 10 price plans currently available 200, related products 202 and related services 204. The distributor 20 obtains a listing of current price plans offered by each provider 200, determines what, if any, optional and mandatory services 204 must be delivered in conjunction with each price plan, as well as which products 202 can or cannot be sold together with each particular subscription. For example, there are often exclusive relationships entered into between providers 10 and mobile device manufacturers, such that some subscriptions cannot be offered with some products. Similarly, some services cannot be offered with some subscription plans. The subscription configuration module includes a database and a rules engine that keeps track of these limitations in order to make sure that only the available subscriptions and options are displayed to the customer based upon the parameters chosen by the customer. For example, if the customer indicates that he wishes to purchase an APPLE IPHONE, the subscription configuration module will only display subscription and subsidy options that may be used with this particular mobile device.

Referring to element 2, a determination is made as to which subsidies are available in view of the other selections made by the customer, such as the mobile device 206 selection, subscription 208 selection and services 210 selection. The providers 10 tend to change subsidy rates frequently, so the subscription configuration module will need to verify that it has the most current subsidy rates. Further checking is done to determine what optional or mandatory services must be delivered to qualify for the subsidy. For example, a subsidy may require that the optional SPOTIFY music service be added to a subscription plan in order to qualify for the subsidy. Note that more than one subsidy may be offered for a particular subscription plan and options package, and the subscription configuration module may choose from among the available subsidies or, if allowed by the business rules, aggregate the subsidies. In some embodiments, the subscription configuration module prevents the offering of negative end user prices (i.e., offering subsidies that are greater than the price of the package being purchased). In some embodiments, the retailer 30 may handle the offered subsidy according to their own rules, such as deciding how much, if any, of the subsidy to share with the customer to lower the customer's price as opposed to increasing the retailer 30's profit margin.

Referring to element 3, a customer credit check is performed according to rules provided by each provider 10, since the provider 10 will be offering services going forward under the selected subscription plan and optional services. Each provider 10 normally has their own credit check rules, and the subscription configuration module includes these requirements in the rules engine. In order to complete the credit check, the subscription configuration module determines the rules 212 set forth by the provider, which normally requires checking the credit worthiness of the customer with external sources 214, such as credit reporting agencies.

Referring to element 4, when mobile devices and/or mobile device subscriptions are being sold, the subscription configuration module must process rules relating to the telephone number to be used with the device and/or under the subscription being purchased. To process these rules, the subscription configuration module determines if there is a new number 216 being assigned, an upgraded number 218 being assigned, or if a previously used number is being ported 220 to a new mobile device. The subscription configuration module must check that the subscription plan and/or subsidy may be offered with the telephone number being used in the current transaction. For example, the subscription configuration module must determine if the services ordered or subsidies offered can be used with the telephone number indicated. For example, there is often a start-up fee charged for a new customer that is receiving a new telephone number. Sometimes customers try to port numbers that they do not own to new mobile devices (for example, the customer's employer owns the telephone number, not the customer). Some providers 10 reject the subsidy offer if the number porting operation fails, which can in some instances occur weeks after the actual purchase.

Referring to element 5, the verification process may include the SMS message 222 verification procedure discussed hereinabove. Some providers 10 require a verification letter 224 to be sent to the customer. If so, this process is handled by the subscription configuration module. The letter is then returned to the retailer 30 by the customer after receipt, after which the retailer 30 releases the order. Delivery 226 of the mobile device to the customer must use a delivery method approved by the provider 10. For example, many providers 10 require that the customer be required to sign upon delivery of the package, and that the package may only be delivered to a registered public physical address (i.e., not to a P.O. box). The subscription configuration module checks to determine that none of the provider 10 rules conflict with rules provided by the retailer 30.

Referring to element 6, as part of the retailer 30's checkout process, the customer confirms all of the displayed order details and accepts the provider 10's Terms & Conditions, which are displayed to the customer and the customer must click a button (not shown) labeled “agree” before the checkout process can be completed. The subscription configuration module logs this, along with the SMS verification code and the IP address of the customer's browser 40. The confirmation process at checkout can fail for a variety of reasons, including it is determined that the customer is already an existing customer, the customer is not the legal owner of the telephone number being used, the customer fails the credit check, the customer fails to provide an acceptable delivery address, etc.

Referring to element 7, delivery is made to the customer, and may involve a rework of the customer check at 228. The optional customer check 228 provides an opportunity for the provider 10 to cancel a submitted order before it leaves storage. For example, in the case of the pre-sale of devices that are not yet in stock (e.g., a pre-order placed for an anticipated release of a new IPHONE model), there is a risk that a customer becomes non-creditworthy by the time of delivery, even though at the time of sale the customer was deemed to be creditworthy. This option gives the provider 10 an opportunity to cancel an order just before delivery if this (or another parameter) is determined to preclude the sale at this point in time. Also, if the mobile device is shipped from the distributor 20's warehouse, the subscription configuration module will send the IMEI number 230 to the relevant provider 10 for activation and for a possible IMEI kick. An IMEI kick is an extra payment made by the provider 10 to the retailer 30 for specific mobile device types identified by the IMEI number. For example, there may be a current campaign which provides for an extra payment for each sale of an IPHONE 5, in black, with 32 Gb of memory. If subscriber identity module (SIM) card(s) are shipped from the distributor 20's warehouse, the subscription configuration module will send the SIM card integrated circuit card identification number (ICCID) 232 to the relevant provider 10 for activation. Most providers 10 require at least the IMEI number to be transmitted to them before they will pay the subsidy.

Referring to element 8, if the customer does not complete the checkout process for any reason, then the subscription configuration module will cancel the subscription from the retailer 30's user interface.

Referring now to FIG. 9, there is schematically illustrated one embodiment flow chart for assigning a new telephone number for a customer 250. At 300, the customer 250 indicates that he wishes to have a new telephone number assigned. This is communicated to the distributor 20, which attempts to fetch a series of available numbers at 302. At 304 it is determined if there are any available numbers stored in an available numbers cache. If there are available numbers contained within the cache, then these are retrieved at 306. If, on the other hand, the cache is empty (or does not contain a minimum quantity of available numbers), the provider 10 is queried at 308 to supply additional available numbers. At 310, it is determined if the option to choose a telephone number is available. If the option to choose a number is not available, the assigned number is displayed to the customer 250 at 312. If the option to choose a number is available, then the available numbers are displayed to the customer 250 at 314 and the customer 250 chooses a number from the list at 316. This causes the distributor 20 system to reserve the chosen number at 318 by contacting the provider 10 to reserve the Mobile Subscriber Integrated Services Digital Network (MSISDN) number at 320. Confirmation of this is communicated to the distributor 20 system and the cache is updated at 322 to indicate that the chosen telephone number is no longer available. The distributor 20 system then communicates to the customer's browser 40 that the chosen telephone number has been successfully reserved.

Referring now to FIG. 10, there is schematically illustrated one embodiment flow chart for upgrading/porting a telephone number for a customer 250. At 400, the customer enters the Global System for Mobile Communications (GSM) telephone number to upgrade/port to a new mobile device. In this context, upgrading refers to extending an existing subscription for an extended period of time in order to receive a new mobile device. The distributor 20 system receives this request and initiates a customer verification process 402 by requesting the provider 10 to validate the MSISDN at 404 and to optionally validate the customer's subscription at 406. The results of these validation steps are returned to the distributor 20 system which determines at 408 if the validation was successful. If the validation failed (e.g., the customer 250 does not own the telephone number he wished to port), a fail message is displayed on the customer's browser 40.

If, on the other hand, the system determines that the verification passed, the provider 10 verifies that the customer 250 is who he purports to be by sending a verification code at 410 to the customer 250 by SMS message. Note that if the provider 10 does not implement a verification process, then the distributor 20 may perform its own verification process. Once the customer receives the verification code sent by SMS message, he inputs the received verification code into his browser 40 at 412. The distributor 20 system receives this input verification code at 414 and transmits it to the provider 10 who verifies at 416 whether it matches the code that was sent and transmits to the distributor 20 the result of this verification. If the verification was determined to be successful at 420, then the customer 250 is informed of this success at 422 by a message in his browser 40. If, on the other hand, the verification failed, this is also communicated to the customer 250 and he is given the option at 424 of re-inputting the previously received verification code, in which case the process returns to 412. The customer 250 is alternatively given the option of receiving a new verification code at 426, in which case the process returns to 410.

Referring now to FIG. 11, there is schematically illustrated one embodiment flow chart for performing a credit check for a customer 250. As part of the credit checking process, the customer 250 is asked to supply his social security number and the customer 250 enters this on his browser 40 at 500. The distributor 20 initiates the process at 502 by transferring the social security number to the provider 10 who performs a credit check at 504 and determines if the customer is authorized to purchase the desired products and/or services. This determination result is passed to the distributor 20 system at 506 where the distributor 20 system determines if authorization was received. If the credit check results in the transaction not being authorized, then a rejection message 508 is displayed on the customer 250 browser 40 at 510. If, on the other hand, the transaction was authorized, this is indicated on the customer 250 browser 40 at 512 and the checkout process continues with FIG. 12.

Referring now to FIG. 12, there is schematically illustrated one embodiment flow chart for confirmation of an order by a customer 250 during a checkout process. The customer 250 is shown an order total on his browser 40 and asked to confirm if the order is complete at 600. Once done, this information is sent to the distributor 20 system, which validates the order at 602. If the order is determined not to be valid at 604 (e.g., the customer was deemed to no longer be creditworthy as explained hereinabove with respect to block 228, an error message 606 is generated by the distributor 20 system and displayed on the customer 250 browser 40 at 608. If, on the other hand, the order is determined to be valid at 604, the order is submitted to the provider 10 at 610. Once the order is accepted by the provider 10, this is communicated to the distributor 20 system. If no acceptance is received by the distributor 20 at 612, then the process returns to 606 to generate an error message for the customer 250. If, on the other hand, confirmation that the order is accepted is received from the provider 10, a summary view of the order is generated at 614 and displayed on the customer 250 browser 40 at 616.

Referring now to FIG. 13, there is schematically illustrated one embodiment flow chart for allowing a retailer 30 to pick a pre-order, such as for a mobile device, that was made before the device was available to be transferred. At 700, the retailer 30 queries the distributor 20 system whether the order is ready to be picked. The distributor 20 verifies at 702 in its database whether the order can be committed. If it is determined at 704 that the order cannot be committed, then the distributor 20 informs (at 706) the retailer 30 that the order cannot be picked and this is displayed to the retailer 30 at 708. If, on the other hand, the order can be committed, then the distributor 20 system optionally communicates with the provider 10 to commit the order at 710. Commitment verification is received by the distributor 20 from the provider 10 at 712. If the order is not committed, then the process returns to 706. If, on the other hand, the order has been committed by the provider 10, then an order commitment message is generated at 714 and displayed to the retailer at 716.

Referring now to FIG. 14, there is schematically illustrated one embodiment flow chart for allowing a retailer 30 to request pre-delivery of devices, such as mobile devices. At 800, the retailer 30 inquires as to whether devices previously ordered are ready to be delivered. At 802, the distributor 20 verifies the state of the order to determine if the provider 10 can commit to delivering the order (e.g., the provider 10 may have a cancellation option). Decision block 804 determines if the order can be finalized and, if not, informs the retailer 30 at 806 that the order cannot be delivered. If, on the other hand, the order can be finalized, the process continues to 808, where the provider 10 finalizes the order and the process continues at 810, where the distributor 20 determines if the order can be committed to the retailer 30. If so, a commitment is confirmed to the retailer at 812.

Referring now to FIG. 15, there is schematically illustrated one embodiment flow chart for allowing a retailer 30 to attempt to cancel a pre-existing order. At 900, the retailer 30 indicates that he wishes to cancel a pre-existing order. At 902, the distributor 20 system retrieves information about the order from a database and, at 904, determines if the order can be cancelled. If the order cannot be cancelled (e.g., because it has already been completed by the provider 10, etc.), then a message about the cancellation failure is generated at 906 and displayed to the retailer 30 at 908. If, on the other hand, the order is at a stage where it can be cancelled, the provider 10 is instructed to cancel the order at 910 and confirmation of cancellation is communicated to the distributor 20 system. If confirmation of cancellation is not received at 912, then the process proceeds to 906. If, on the other hand, confirmation of cancellation is received from the provider 10, a message confirming that the order has been successfully cancelled is generated at 914 and displayed to the retailer 30 at 916.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

What is claimed:

1. A computer-implemented system, comprising:
a provider server operatively coupled to a network and storing subscription information relating to one or more subscription plans;
a retailer server operatively coupled to the network and hosting a website operative to display at least a portion of said information relating to one or more subscription plans;
a customer browser operatively coupled to the network and operative to view said website; and
a third party server operatively coupled to the network and storing a subscription configuration module, wherein the subscription configuration module is operative to:
receive a request from the retailer server for information about said one or more subscription plans;
retrieve from the provider server said information relating to said one or more subscription plans; and
inject content including said information about said one or more subscription plans into the customer's browser.

2. The system of claim 1, wherein the network comprises the Internet.

3. The system of claim 1, wherein the subscription plans comprise subscription pricing and subsidy information relevant to a geographic market of the customer.

4. The system of claim 1, wherein the subscription plans comprise mobile device service subscription plans.

5. The system of claim 3, wherein the subsidy information comprises a discount on the subscription plan when a predetermined mobile device is purchased with the subscription plan.

6. The system of claim 1, wherein the provider comprises a mobile communication service provider, the retailer comprises a mobile device retailer, and the third party comprises a mobile device distributor.

7. The system of claim 1, wherein the provider server and the subscription communication module communicate using an application programming interface.

8. The system of claim 1, wherein the content injected by the subscription configuration module includes formatting to match other content in said website.

9. The system of claim 1, wherein the content injected by the subscription configuration module includes functionality enabling the customer browser to send customer information to the subscription configuration module without said customer information passing through the retailer server.

10. The system of claim 9, wherein the customer information comprises confirmation of a chosen subscription plan of the one or more subscription plans the customer wishes to purchase.

11. The system of claim 10, wherein the subscription configuration module is operable to determine if the customer is qualified to purchase the chosen subscription plan.

12. The system of claim 11, wherein the subscription configuration module is operable to check a telephone number of the customer to determine if there exists an unexpired prior subscription associated with the telephone number that disqualifies the customer from purchasing the chosen subscription plan.

13. The system of claim 11, wherein the subscription configuration module exchanges data with the provider server to determine if the customer is qualified to purchase the chosen subscription plan.

14. The system of claim 11, wherein the retailer server is operable to handle payment from the customer once the subscription configuration module determines that the customer is qualified to purchase the chosen subscription plan.

15. The system of claim 14, wherein the retailer server is operable to notify the subscription configuration module that payment for the chosen subscription plan has been completed.

16. The system of claim 15, wherein the subscription configuration module is operable to notify the provider server that payment for the chosen subscription plan has been completed.

17. The system of claim 1, wherein the subscription communication module and the retailer server communicate using Representational State Transfer (REST) software architecture.

18. The system of claim 1, wherein the customer browser and the subscription communication module communicate using an application programming interface and a web client.

19. The system of claim 1, wherein the customer browser and the retailer server communicate using an application programming interface and a web client.

20. A method, comprising the steps of:
a) storing subscription information relating to one or more subscription plans on a provider server;
b) hosting a website on a retailer server operative to display at least a portion of said information relating to one or more subscription plans;
c) viewing said website with a customer browser; and
d) providing a subscription configuration module stored on a third party server, wherein the subscription configuration module is operative to:
d.1) receive a request from the retailer server for information about said one or more subscription plans;
d.2) retrieve from the provider server said information relating to said one or more subscription plans; and
d.3) inject content including said information about said one or more subscription plans into the customer's browser.

21. The method of claim 20, wherein the subscription plans comprise subscription pricing and subsidy information relevant to a geographic market of the customer.

22. The method of claim 20, wherein the subscription plans comprise mobile device service subscription plans.

23. The method of claim 22, wherein the subsidy information comprises a discount on the subscription plan when a predetermined mobile device is purchased with the subscription plan.

24. The method of claim 20, wherein the provider comprises a mobile communication service provider, the retailer comprises a mobile device retailer, and the third party comprises a mobile device distributor.

25. The method of claim 20, wherein communication in step (d.2) occurs using an application programming interface.

26. The method of claim 20, wherein the content injected by the subscription configuration module includes formatting to match other content in said website.

27. The method of claim 20, wherein step (d.3) comprises injecting content including functionality enabling the customer browser to send customer information to the subscription configuration module without said customer information passing through the retailer server.

28. The method of claim 20, further comprising the step of:
e) transmitting customer information from the customer browser to the subscription configuration module without said customer information passing through the retailer server.

29. The method of claim 27, wherein the customer information comprises confirmation of a chosen subscription plan of the one or more subscription plans the customer wishes to purchase.

30. The method of claim 29, further comprising the step of:
d.4) determine if the customer is qualified to purchase the chosen subscription plan.

31. The method of claim 30, further comprising the step of:
d.5) check a telephone number of the customer to determine if there exists an unexpired prior subscription associated with the telephone number that disqualifies the customer from purchasing the chosen subscription plan.

32. The method of claim 29, further comprising the step of:
d.4) exchange data with the provider server to determine if the customer is qualified to purchase the chosen subscription plan.

33. The method of claim 30, further comprising the step of:
e) handling payment from the customer using the retailer server once the subscription configuration module determines that the customer is qualified to purchase the chosen subscription plan.

34. The method of claim 33, further comprising the step of:
f) using the retailer server to notify the subscription configuration module that payment for the chosen subscription plan has been completed.

35. The method of claim 34, further comprising the step of:
g) using the subscription configuration module to notify the provider server that payment for the chosen subscription plan has been completed.

36. The method of claim 20, wherein the subscription communication module and the retailer server communicate using Representational State Transfer (REST) software architecture.

37. The method of claim 20, wherein the customer browser and the subscription communication module communicate using an application programming interface and a web client.

38. The method of claim 20, wherein the customer browser and the retailer server communicate using an application programming interface and a web client.
